(19) United States
(12) Patent Application Publication
(10) Pub. No.: US 2011/0151398 A1
(43) Pub. Date: Jun. 23, 2011

(54) DENTAL TRAY AND METHOD FOR FABRICATING THE SAME

(75) Inventors: Ching Ho, Taipei City (TW); Ting Ting Wang, Taipei City (TW)

(73) Assignee: EASTING BIOTECHNOLOGY COMPANY LIMITED., Taipei City (TW)

(21) Appl. No.: 12/643,696

(22) Filed: Dec. 21, 2009

(51) Int. Cl. A61C 9/00

(52) U.S. Cl. 433/45; 433/48

(57) ABSTRACT

A dental tray and a method for fabricating the same are presented. The dental tray includes a thermoplastic material and a fabric bonded to the thermoplastic material. The method for fabricating a dental tray includes preparing a thermoplastic material and a fabric, and bonding the thermoplastic material to the fabric.

### BACKGROUND OF THE INVENTION

1. Field of Invention

The present invention relates to a dental tray and a method for fabricating the same.

2. Related Art

A conventional dental tray is made of a thermosetting plastic, which is formed by mixing a primary agent monomer, a hardener monomer, and a filling material together. The dental tray is placed into the mouth of a patient before polymerization and hardening, and then manually kneaded in the mouth so as to match a teeth portion. Upon the polymerization and hardening of the primary agent monomer and the hardener monomer, a rigid structure is formed. As such, the dental tray may be used as a plastic structure conforming to the mouth of a person.

Moreover, in a method for fabricating a dental tray employed by professional organizations such as dental clinics and hospitals, moldable clay is closely adhered to the teeth of a patient so as to obtain a teeth mold matching the teeth. Afterward, a solid teeth mold is formed by using gypsum or other solid materials. Then, a dental tray to be sleeved on the teeth of the patient is fabricated by using the solid teeth mold. Such a technology for fabricating a dental tray is known in the art, so the details will not be described herein again.

The fabricated dental tray has many functions. For example, an agent such as a fluorine-containing agent or a tooth whitening agent is applied or placed into the dental tray, and then the dental tray is sleeved on the teeth of a user, such that the agent such as the fluorine-containing agent or the tooth whitening agent contacts the teeth and is isolated from saliva.

For example, for current tooth whitening technologies, laser or a hydrogen peroxide-containing agent may be applied. Laser whitening requires a patient to go to a dental clinic and find a dentist to perform a whitening surgery, and can achieve an effective and uniform whitening effect under the control of the dentist, and is also quite safe, but the cost is rather high. The method of applying the hydrogen peroxide-containing agent is cheap and easy to use, since a user generally applies the hydrogen peroxide-containing agent onto the teeth in the mouth by himself/herself. However, uneven application easily occurs (teeth and teeth gap), and enzymes in saliva easily interfere with the hydrogen peroxide-containing agent, resulting in a non-uniform and ineffective whitening effect. Moreover, the agent is swallowed together with the saliva in a rather high ratio, causing potential safety hazards.

For the above problems in the prior art resulting from using a whitening agent, although the agent can be isolated from saliva with the assistance of the dental tray, other problems still exist. A dental tray fabricated by a dental tray technician in a dental clinic or hospital can be sleeved and closely bonded to the teeth, and can thus solve the problem that the agent and saliva are swallowed together. However, it takes a long period of time and a high cost to fabricate such a dental tray, and the dental tray is not suitable for users that need to replace the dental tray by themselves. In addition, since portions on the inner side of the dental tray in contact with the teeth cannot assist with the dispersion and distribution of the agent, the agent cannot evenly contact the teeth unless the agent can be evenly applied on the inner side of the dental tray. On the other hand, although the thermoplastic dental tray in the prior art as mentioned above can be conveniently used by a user himself/herself, portions on the inner side thereof in contact with the teeth also cannot assist with the dispersion and distribution of the agent, so that the agent also cannot evenly contact the teeth. Even if the agent can be made to evenly contact the teeth, the dental tray may be taken off too early or too late, since the agent has a certain therapeutically effective period of time and the user cannot know whether the agent has completed its function or not in use.

Therefore, how to solve the disadvantages of the conventional dental tray is a major topic in this invention.

### SUMMARY OF THE INVENTION

Accordingly, the present invention is a dental tray capable of being closely adhered to teeth through simple operations and a method for fabricating the same.

The present invention is also a dental tray capable of being uniformly dispersing and distributing a substance placed on a contact surface between the dental tray and teeth and a method for fabricating the same.

The present invention is also a dental tray capable of indicating an operating temperature range in a process for shaping the dental tray.

The present invention is also a dental tray capable of indicating that an agent formed on a contact surface between the dental tray and teeth has completed its function.

In order to achieve the above objectives, the dental tray of the present invention comprises a thermoplastic material and a fabric bonded to the thermoplastic material.

In one aspect of the present invention, the dental tray further comprises a temperature sensing element for detecting an operating temperature of the thermoplastic material in a hot-melt shaping process.

In one aspect of the present invention, the dental tray further comprises a dosage indicating element for indicating a functional state of an agent formed on a contact surface between the dental tray and teeth.

The method for fabricating a dental tray comprises: preparing a thermoplastic material and a fabric, and bonding the thermoplastic material to the fabric.

Compared with the prior art, through the dental tray and method for fabricating the same of the present invention, the dental tray can be closely adhered to teeth through simple operations, can uniformly disperse and distribute a substance placed on a contact surface between the dental tray and teeth, and can further detect the operating temperature of the thermoplastic material in the shaping process through the temperature sensing element, and indicate that an agent formed on the contact surface between the dental tray and teeth has completed its function through the dosage indicating element.

### BRIEF DESCRIPTION OF THE DRAWINGS

The present invention will become more fully understood from the detailed description given herein below for illustration only, and thus are not limitative of the present invention, and wherein:

FIG. 1 is a schematic structural view of a dental tray according to the present invention;

FIG. 2 is a flow chart of a method for fabricating a dental tray according to the present invention;

FIG. 3 is a schematic cross-sectional view of a dental tray fabricated by the method for fabricating a dental tray according to the present invention; and

FIG. 4 is a flow chart of a process for shaping the dental tray according to the present invention.

### DETAILED DESCRIPTION OF THE INVENTION

The present invention is described below with specific embodiments, so that persons skilled in the art can easily understand other advantages and effects of the present invention from the disclosure of the specification. The present invention may also be implemented and applied according to other embodiments, and various modifications and variations may be made to the details in the specification based on different views and applications without departing from the spirit of the present invention.

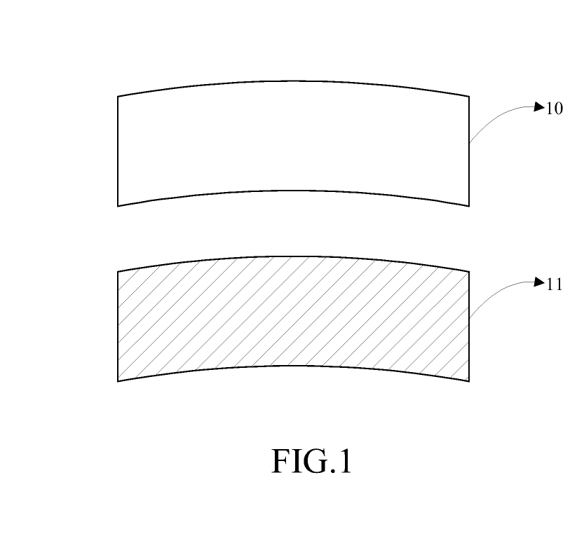

FIG. 1 is a schematic structural view of a dental tray according to the present invention. Referring to FIG. 1, the dental tray of the present invention comprises a thermoplastic material 10 and a fabric 11 bonded to the thermoplastic material 10.

In a preferred embodiment of the present invention, the thermoplastic material 10 and the fabric 11 are bonded by heating and pressing. The thermoplastic material 10 may be made of, but not limited to, ethylene-vinyl acetate (EVA) or thermoplastic poly-urethane (TPU). Other materials are also available, as long as the materials used each have a first glass transition temperature range of 70-95° C. and a second glass transition temperature range of 140-160° C. The fabric 11 is made of a raw material capable of adsorbing liquid or semi-liquid substances, such as an absorbent gauze, a non-woven fabric, or a water-soluble acrylic resin. The fabric 11 and the heating and pressing process will be described in detail below.

The dental tray of the present invention preferably has a porosity of 40-60% (volume ratio), with most of pore size 20-50 μm, and the fabricated product is chemical resistant and non-toxic.

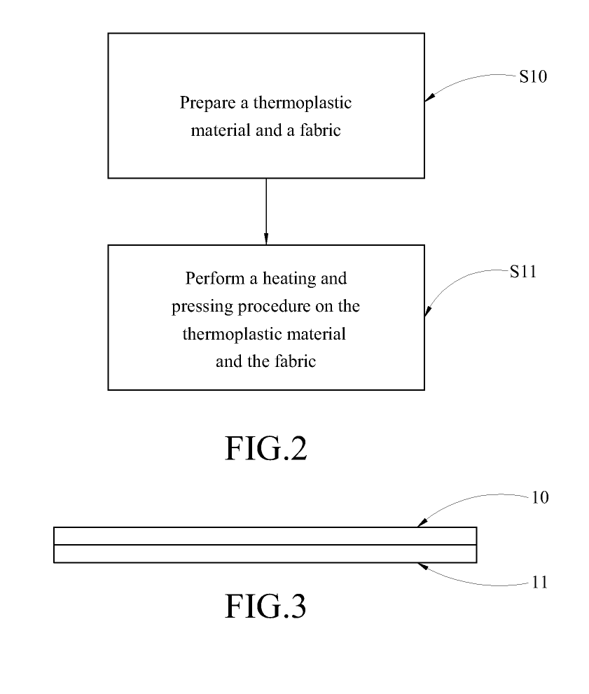

FIG. 2 is a flow chart of a method for fabricating a dental tray according to the present invention. Referring to FIG. 2, in Step S10, a thermoplastic material 10 and a fabric 11 are prepared. In the present invention, preferably, the thermoplastic material 10 is made of TPU (having a molecular weight of 1,500,000), and has a first glass transition temperature range of 70-95° C. and a second glass transition temperature range of 140-160° C. In the present invention, preferably, the thermoplastic material 10 and the fabric 11 has the same cross-sectional area, or the fabric 11 has a cross-sectional area slightly smaller than that of the thermoplastic material 10; and the dental tray has a shape approximately conforming to a curvature of an upper tooth row and/or a lower tooth row, and has a width at least sufficient for wrapping the upper tooth row and/or the lower tooth row. Then, Step S11 is performed.

In Step S11, a heating and pressing procedure is performed on the thermoplastic material 10 and the fabric 11. In this embodiment, operating conditions of the heating and pressing procedure comprise: direct temperature, 5-10° C. higher than the first glass transition temperature range; pressing force, 10-20 gf/cm²; ultrasonic wave, above 20 kHz; and operating time, 3-5 seconds. The above fabrication method and conditions can ensure the bonding strength between the thermoplastic material 10 and the fabric 11, without reducing the controlled release capability of the fabric 11. The fabricated product was subjected to the tear test, and proved to have sufficient adhesion force. The fabricated product was then subjected to the mercury intrusion test, and it is found that the porosity decreases from 53% to 41%.

Preferably, in this embodiment, the fabrication method of the fabric 11 may be, for example, but not limited to, as follows. Firstly, an absorbent gauze is prepared.

Afterward, the absorbent gauze is immersed into a methanol solution containing 5%-8% methylcellulose (having a molecular weight of 400,000±10%). Then, the absorbent gauze is taken out of the methanol solution, and a water-soluble acrylic resin (with a solid content of 15%-20%, and having a molecular weight of 1,000,000±10%) is sprayed onto the surface of the absorbent gauze before the methanol solution on the absorbent gauze dries up. Afterward, the absorbent gauze is dried in an oven at a temperature of 102-105° C. (a reasonable operating temperature range of several Celsius degrees), thus forming the fabric 11.

After the fabric 11 formed by the above fabrication method was subjected to the mercury intrusion test, and the following characteristics were obtained: porosity, 53% (volume ratio); most of pore size, 32-34 μm; and distribution rate, 92%. After the fabricated product was placed into 30% hydrogen peroxide for dissolution experiment, with pH value ranging from 0.1 to 8.5, no oxygen evolution reaction took place. Then, the hydrogen peroxide solution was subjected to infrared (IR), ultraviolet (UV), and visible spectrometry (VIS) scanning, and no precipitate was observed, proving that the fabricated product is chemical resistant in use.

FIG. 3 is a schematic cross-sectional view of a dental tray fabricated by the method for fabricating a dental tray according to the present invention. Referring to FIG. 3, through the method for fabricating a dental tray of the present invention, the thermoplastic material 10 and the fabric 11 can be closely bonded together.

In another embodiment of the present invention, the dental tray further comprises a temperature sensing element 12 for detecting an operating temperature of the thermoplastic material 10 in a shaping process. In this embodiment, the temperature sensing element 12 is formed by a thermosensitive color-changeable microcapsule and a dual-dosage form epoxy resin. The fabrication method of the temperature sensing element 12 may be, for example, but not limited to, injecting the thermosensitive color-changeable microcapsule and the dual-dosage form epoxy resin into a small silica gel column serving as a mold, and after hardening, the thermosensitive color-changeable microcapsule and the dual-dosage form epoxy resin are taken out of the mold, thus forming the temperature sensing element 12. The thermosensitive color-changeable microcapsule may be a product developed by Toray of Japan or Merck. The thermosensitive color-changeable microcapsule should be color-changeable at 75-80° C., preferably with a lag time of shorter than one minute. The temperature sensing element 12 fabricated by the above fabrication method is sensitive to temperature and completely non-toxic. The temperature sensing element 12 is bonded to the thermoplastic material 10 and/or the fabric 11.

In still another embodiment of the present invention, the dental tray further comprises a dosage indicating element 13 for indicating a functional state of an agent formed on a contact surface between the dental tray and teeth. The dosage indicating element 13 is in the form of a salt bridge formed by a redox indicator, an electrolyte, and a hydrosol. The redox indicator may be indigo carmine [C₁₆H₁₀N₂O₈S₂], the electrolyte may be potassium chloride or sodium chloride, and the hydrosol may be agar or gelatin. The dosage indicating element 13 fabricated by the above fabrication method is sensitive to oxidizing agents and completely non-toxic, and thus meets the requirement for use in the mouth. In a preferred embodiment, the fabrication method is as follows: firstly, 3% redox indicator, 15% electrolyte, and 9% hydrosol are respectively prepared and heated to about 90° C., blended together and then injected into a mold, and taken out after cooling and hardening, thus forming the dosage indicating element 13. Response of the dosage indicating element 13 fabricated by the above fabrication method to oxidation-reduction potential is shown in Table 1, and the response lag is shorter than that visible to the human eye.

TABLE 1
Response of Indigo Carmine to Oxidation-Reduction Potential

Electric Potential (Volt)

| | −1.8 | −1.35 | −0.9 | −0.45 |
|---|---|---|---|---|
| Color | Green | Burnt Sienna | Red | Yellow |

In the Table 1, Electric Potential represents a standard reduction potential relative to standard hydrogen electrode (SHE), the reaction is 2H₂O═H₂O₂+2H⁺+2e⁻, and the oxidation-reduction potential is controlled by using H₂O₂ activity.

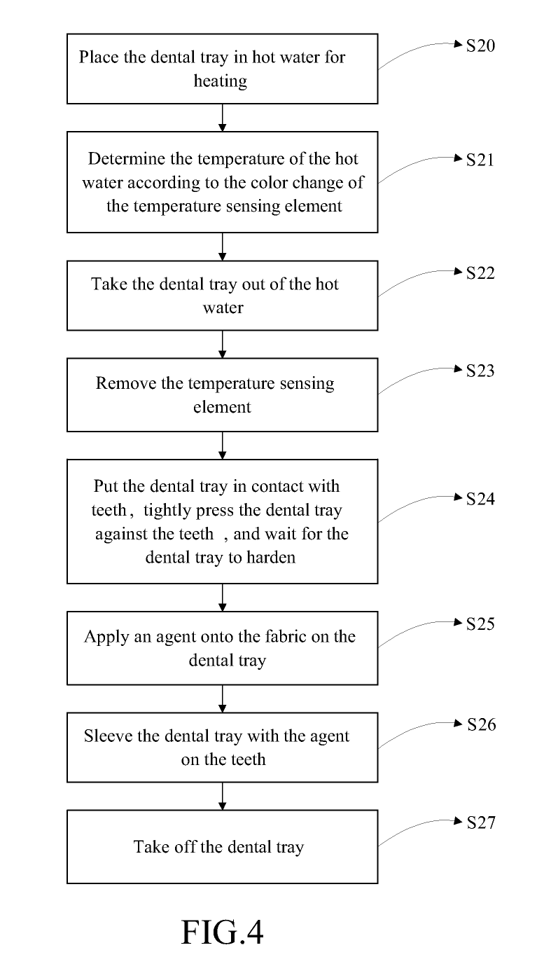

FIG. 4 is a flow chart of a process for shaping the dental tray according to the present invention. Through the shaping step, the dental tray can be shaped to conform to an upper tooth row and/or a lower tooth row of a user. In this embodiment, for the convenience of overall illustration, the dental tray of the present invention comprises the temperature sensing element and the dosage indicating element. However, in other embodiments, the dental tray may optionally not comprise the temperature sensing element and/or the dosage indicating element.

In Step S20, the dental tray is placed in hot water for heating (other heating methods may also be used in other embodiments). Then, Step S21 is performed.

In Step S21, the temperature of the hot water is determined according to the color change of the temperature sensing element. In this embodiment, it is assumed that when the color of the temperature sensing element changes into pink, it indicates that the temperature exceeds 75° C., that is, the thermoplastic material is moldable. Then, Step S22 is performed.

In Step S22, the dental tray is taken out of the hot water. Then, Step S23 is performed.

In Step S23, the temperature sensing element is removed. Then, Step S24 is performed.

In Step S24, the dental tray is placed into the mouth of a user, a surface of the dental tray having the fabric is adhered to teeth, one end of the dental tray is placed between the upper tooth row and upper lip (or the lower tooth row and lower lip) and bent along the teeth toward the oral cavity, and the dental tray is tightly pressed against the teeth by using fingers. After hardening, the fabrication of a dental tray conforming to the shape of the teeth of the user is completed. Then, Step S25 is performed.

In Step S25, in the process of tooth whitening or dental care, the user applies a whitening agent or a dental care agent such as a fluorine-containing agent (agents of different types may also be used in other embodiments) onto the fabric on the dental tray. Then, Step S26 is performed.

In Step S26, the dental tray with the whitening agent or the dental care agent is sleeved on the teeth, and tooth whitening or dental care is carried out according to use time, limitation, and cycle specified in the specification of the whitening agent or the dental care agent. It should noted that, at the moment the dental tray is worn, the whitening agent or the dental care agent has the highest oxidizing ability, and the dosage indicating element should be green (may also be other colors in other embodiments); and when the oxidizing ability decreases, the dosage indicating element firstly becomes red (may also be other colors in other embodiments) and then becomes yellow (may also be other colors in other embodiments), indicating that the whitening agent or the dental care agent is no longer therapeutically effective. Then, Step S27 is performed.

In Step S27, the user takes off the dental tray, thus completing tooth whitening or dental care.

Through the dental tray and method for fabricating the same of the present invention, the dental tray can be closely adhered to teeth through simple operations, can uniformly disperse and distribute a substance placed on a contact surface between the dental tray and teeth, and can further detect the operating temperature of the thermoplastic material in the shaping process through the temperature sensing element, and indicate that an agent formed on the contact surface between the dental tray and teeth has completed its function through the dosage indicating element.

What is claimed is:

1. A dental tray, comprising:
a thermoplastic material; and
a fabric, bonded to the thermoplastic material.

2. The dental tray according to claim 1, wherein the thermoplastic material has a first glass transition temperature range of 70-95° C.

3. The dental tray according to claim 1, wherein the thermoplastic material is made of ethylene-vinyl acetate (EVA) or thermoplastic poly-urethane (TPU).

4. The dental tray according to claim 1, wherein the fabric is made of an absorbent gauze or a water-soluble acrylic resin.

5. The dental tray according to claim 1, further comprising: a temperature sensing element, bonded to the thermoplastic material and/or the fabric, for detecting an operating temperature of the thermoplastic material in a shaping process.

6. The dental tray according to claim 5, wherein the temperature sensing element is formed by a thermosensitive color-changeable microcapsule and a dual-dosage form epoxy resin.

7. The dental tray according to claim 1, further comprising: a dosage indicating element, for indicating a functional state of an agent formed on a contact surface between teeth and the fabric.

8. The dental tray according to claim 1, wherein the dosage indicating element is in the form of a salt bridge formed by a redox indicator, an electrolyte, and a hydrosol.

9. A method for fabricating a dental tray, comprising:
preparing a thermoplastic material and a fabric; and
performing a heating and pressing procedure on the thermoplastic material and the fabric.

10. The method for fabricating a dental tray according to claim 9, wherein the thermoplastic material has a first glass transition temperature range of 70-95° C., and operating conditions of the heating and pressing procedure comprise: direct temperature, 5-10° C. higher than the first glass transition temperature range; pressing force, 10-20 gf/cm²; ultrasonic wave, above 20 kHz; and operating time, 3-5 seconds.
